(19) United States
(12) Patent Application Publication
(10) Pub. No.: US 2006/0288362 A1
(43) Pub. Date: Dec. 21, 2006

(54) Technique for providing advertisements over a communications network delivering interactive narratives

(76) Inventors: Theodore Robert Pulton JR., Fairfield, CT (US); Nils Huehnergarth, Chappaqua, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/154,746

(22) Filed: Jun. 16, 2005

(51) Int. Cl. H04N 5/445; H04N 7/10; G06F 13/00; H04N 7/025; G06F 3/00

(52) U.S. Cl. 725/34; 725/35; 725/40

(57) ABSTRACT

Advertisements associated with actions related to interactive programs are provided over a communications network. Advertisement content is based on information related to interactive program content. Records are maintained in a database for dynamically managing the assignment of advertisement locations within interactive programs to advertisers and their corresponding advertisements, and for managing the distribution of advertisements to the appropriate individuals at the appropriate times. Data items related to a request for advertisement locations from a collection of advertisement locations are associated with various decision points within interactive programs. The data items are disposed in a plurality of fields arranged to reserve advertisement locations so that the appropriate advertisements can be provided at the appropriate times within interactive programs. Advertisement content is based on information related to interactive program content.

### FIELD OF THE INVENTION

The invention relates to a communications system and method, and more particularly to a system and method for providing advertisements over a communications network delivering interactive programs.

### BACKGROUND OF THE INVENTION

It is known in the art to send advertisements to an individual based on the individual's possible affinity or predisposition. Typically, information collected over time about the person is used to predict the person's affinity or predisposition. This information is useful for describing a general profile about the individual, but cannot be used to determine what the individual is thinking and feeling at any given moment. Although this information can be updated and modified, it is still static and general. That is, at best this information can be used to describe the general affinity or predisposition of the individual, but cannot be used to determine the current mind-set or emotional state of the individual, from which a current affinity or predisposition (for example) of the individual can be determined.

General and static information about the individual cannot be used to determine the individual's mind-set or emotional state at a given moment, on account of fluctuations in an individual's mind-set and emotional state. For example, an individual viewing an action based television show would have a mind-set or emotional state different from when the same individual views a romance based television show. Further, the individual's mind-set and emotional state can fluctuate within a single television show, such as the action show mentioned above.

At best, general and static information collected over time about the individual is good for describing a general classification of the individual, but is of little use for determining the individual's emotional state or mind-set at any specific point in time during these television shows. Thus, advertisements based on this information are ineffective because the mind-set or emotional state are unknown at the time the advertisement is presented to the individual.

One type of media where much about an individual can be determined is interactive narratives. Interactive narratives and their technological infrastructures provide a new environment for advertisers. One example infrastructure, is cable television that delivers interactive digital television programming over a community access television (CATV) system to subscribers. Specifically, in delivering the interactive digital television programming, a headend in the CATV system distributes from an interactive video server, interactive program streams containing program material over a network, such as a hybrid fiber/coax network, to various subscribers in a neighborhood. Fiber connects central servers, switches, demultiplexers, multiplexers, modems, and demodulators to nodes, which serve hundreds of subscribers. Coaxial cable links each node to subscribers' digital terminals (e.g., set-top boxes) at the subscribers' location. The digital terminals decode interactive program streams for display and sends command signals from the subscribers to the servers at the headend. The delivery of interactive program streams and the use of forward control channels and return signals (commands) from subscribers, support the interactive process between subscribers and the interactive program streams from the headend. The headend manages the interactive process and the interactive program stream (e.g., including interactive narrative).

Other infrastructures that support interactive narratives are the Internet and wireless broadband, which can support the distribution of interactive narratives and provide the control signals necessary for controlling an interactive process.

What advertising needs is the ability to determine an individual's mind-set or emotional state and deliver to the individual at the appropriate time an advertisement that is designed for the specific mind-set or emotional state. This would be an extremely effective way to advertise and would be extremely beneficial to the advertising community.

### SUMMARY OF THE INVENTION

The invention overcomes prior art limitations by providing advertisers a system and method for achieving maximum attention from an individual during presentation of an advertisement. An advertisement is most effective when it is composed to reflect an individual's mind-set and/or emotional state, and is presented to the individual at the appropriate time.

Interactive narratives and their technological infrastructures provide an environment where one can determine an individual's current mind-set and/or emotional state and deliver to the individual an advertisement at the appropriate time. An advertisement associated with an action related to interactive program content is selected from a group of advertisements and provided over a communications network. The advertisement content is based on information related to the interactive program content. For example, the information can be content about one or more segments proceeding and/or following the action, content about one or more decisions points, one or more answers presented, behavior patterns revealed by choosing one or more segments, and/or analysis of one or more segments. The analysis can include providing a context of the one or more segments and/or provides a mind-set and/or an emotional state of an individual viewing the one or more segments.

Records are maintained in a database for dynamically managing the assignment of advertisement locations within interactive programs to advertisers and their corresponding advertisements. Also managed is the distribution of advertisements to the appropriate individuals at the appropriate times. Data items related to a request for an advertisement location from a collection of advertisement locations are associated with various decision points within an interactive program. The data items are disposed in a plurality of fields arranged to reserve the advertisement location so that the appropriate advertisement can be provided at the appropriate time within the interactive program. The advertisement content is based on information related to the interactive program content.

### BRIEF DESCRIPTION OF THE DRAWINGS

Further objects, features and advantages of the invention will become apparent from the following detailed description taken in conjunction with the accompanying drawings, in which:

FIG. 1 illustrates a block diagram of the invention with a hybrid fiber coax cable CATV system;

FIG. 2 illustrates a conceptual diagram of the relationship between an interactive narrative and advertisement locations;

FIG. 3 illustrates tables used to manage advertisement locations;

FIG. 4 is a flowchart describing a process for preparing data associated with advertisement locations;

FIG. 5 illustrates components of the advertisement server in the system of FIG. 1;

FIG. 6 is a flowchart describing a process for reserving an advertisement location; and

FIG. 7 is a flowchart describing a process for providing an advertisement in response to a choice made in an interactive narrative.

### DETAILED DESCRIPTION

Providing an advertisement to an individual at the moment when the individual is most likely to be receptive to the advertisement, and knowing what type of advertisement the individual would most likely be receptive to, would be most advantageous to advertisers. To achieve this, one would like to know as much as possible about the individual's current mind-set (e.g., mental attitude or inclination) or emotional state at a given moment and would need a means for delivering the advertisement at the given moment.

Information regarding the individual's mind-set or emotional state reflect what the individual would be interested in hearing or viewing. With this information, advertisers can develop advertisements that target the individual's mental-state or emotional state at a given moment. To determine this information, one needs to either interact with the individual at the given moment or be able to monitor the individual at the given moment. By interacting with or monitoring the individual, the individual reveals directly or indirectly information about the individual's mind-set or emotional state.

Interactive narratives and their technological infrastructures provide an environment where one can monitor an individual's interaction with a narrative at a given moment. Much about an individual's mind-set and emotional state can be determined by monitoring the individual's interaction with an interactive narrative. An interactive narrative (i.e., interactive program, interactive program content) can be for example, an interactive movie, interactive game show, game show, reality show, experiential program and interactive branded entertainment, etc. The various decisions that the individual makes reveal much about the individual's mind-set or emotional state at the time around the decision. Thus, creating an environment where advertisers can compose highly structured advertisements that reflect the mind-set or emotional state and can deliver the advertisements to the individuals at the appropriate time would be extremely effective.

An interactive narrative provides an individual (e.g, viewer) the opportunity to select from several possible story line options at decision points embedded within the narrative. By choosing various options, the individual determines the outcome of the final story. The individual's choices vary the context of the story and determine the success and failure of characters or events described in the interactive narrative (e.g., interactive movie). The individual's choices may be, for example, in the form of inputting commands, responses or other data.

Within an interactive narrative there are decision points, for example five or six. At each decision point, there are options to choose by an individual. A new character or plot twist may be introduced at each decision point. Around the time of the various decision points, the individual's attention level is the highest. Thus, providing a unique opportunity for advertisers to brand time-periods around decision points with advertisements.

Also, choices made by an individual during an interactive narrative are used to categorize viewers into identifiable types of mind-sets or emotional states. Example mind-sets and emotional states are: identifiable behavior patterns, personality types, and lifestyle traits according to, but not limited to, generally accepted methodologies such as Myers Briggs Type Indicator® (MBTI), Dimensions of Behavior (DiSC)®, Neuro-Linguistic Programming (NLP) Sorting Patterns or any other predetermined psychographic preferences or affinities, or any other sociological, psychological and personality typing or aggregating techniques.

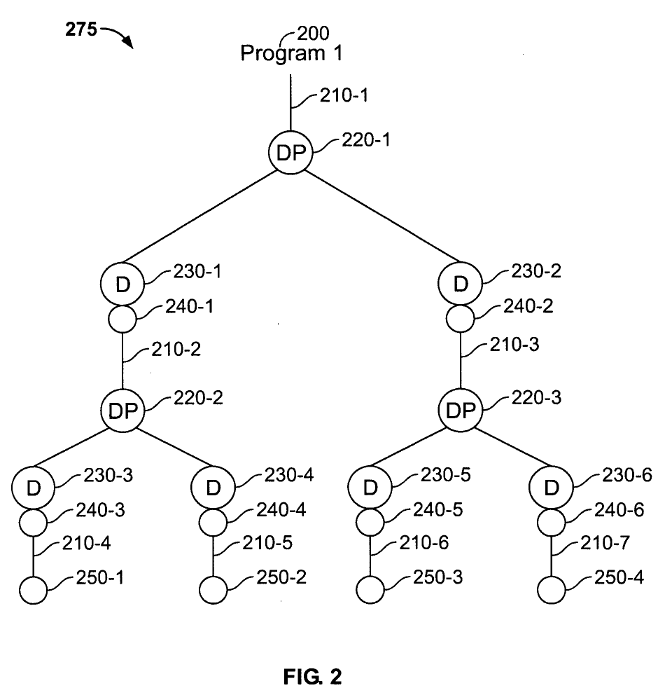

Conceptually, an interactive narrative can be defined as a series of branches within a decision tree diagram 275, as illustrated in FIG. 2. FIG. 2 shows a decision tree diagram for an interactive narrative denoted as Program 1 200. It should be realized that decision tree diagram 275 is exemplary, and therefore can take on various “shapes” and “sizes.” Program segments 210-1 through 210-7, represent the narrative segments (e.g., movie segments) the individual has to choose from within Program 1 200 and decision points are denoted by 220-1 through 220-3. Associated with decision points 220-1 through 220-6 are advertisement locations 240-1 through 240-6. These advertisement locations are conceptual representations of where advertisements can be located within the interactive narrative, e.g., Program 1 200.

It should be noted that the advertisement locations illustrated in decision tree diagram 275 are exemplary, and that the advertisement locations can also be located prior to decisions 230-1 through 230-6, prior to and after decision points 220-1 through 220-3 and in any combination thereof.

The content within the segments comprising decision tree diagram 275 is analyzed such that the various individual and combinations of branches are categorized into mind-sets and/or emotional states. For example, identifiable behavior patterns, personality types, lifestyle traits and other such criteria. These categories can be used to describe individuals, for example, as a specific “type” within the hierarchies of known methodologies such as MBTI, DiSC® or NLP. For example, the culmination of decisions that lead to the narrative's conclusion at type-advertisement locations 250-1 through 250-4 yields a series of “silos” of like-minded individuals. Analysis of these “types” of individuals are aggregated and identified for advertisers to reach with advertisements at advertisement locations 250-1 through 250-4. As mentioned above, these advertisements are tailored to the traits and behaviors the individuals collectively demonstrated during the period of the interactive narrative.

When an individual responds to the choices within Program 1 200, by virtue of their decisions at each decision point 220-1 through 220-3, an identifiable mind-set or emotional state is revealed, such as behavior pattern, personality type or lifestyle trait, at the time of the responses. By reviewing and analyzing segments, decisions, decision points and any combination thereof, one can determine and/or predict the mind-set or emotional state of the individuals who choose these segments, decisions, and decision points. Knowing an individual's mind-set or emotional state, an advertiser can specifically target the individual with a specific advertisement at the moment of the decision or the moment after decision. Thus, the decision path that the individual chooses reveals, for example, specific behavioral or emotional or lifestyle characteristics that can be effectively targeted by advertising.

Further, information about the segments content, context, characters, segments where characters appear, decisions that, for example, reflect favorably or unfavorably on characters is used by advertisers to guide the creation of their advertisement. This information is useful because it can be used to determine and/or predict an individual's mind-set or emotional state at a given time and an advertiser's message can be contextually aligned within the segment(s) (e.g. story line(s)) and structured specifically to match the behavior pattern or lifestyle trait as revealed by the individual's decision, and thus the individual's mind-set or emotional state. For example, when an individual makes a decision that is favorable to a particular character, much is revealed about the individual. Having information about a segment allows an advertiser to develop, for example, an advertisement consistent with the segment. It should be noted that the information used to guide development of the advertisements can be based on individual or multiple segments 210-1 through 210-7, and individual or multiple decision points 220-1 through 220-3, depending on the advertisement location and desires of the advertiser.

Moreover, the content, context, and characters of each decision 230-1 through 230-6 are compared, analyzed and briefed for use by advertisers. This information is also used to guide the development of advertisements, which is beneficial to advertisers because much about an individual's mind-set or emotional state is revealed, including personal values, lifestyle and traits, when they make a decision.

Advertisers are made privy to the content, sorting patterns and analysis of the narrative in advance and are thus able to structure advertisements that specifically address the individual's mind-set or emotional state around the time of a decision. An advertiser can be, for example, a third party such as a production house or trafficking agent, etc. An advertisement for a product or service may be created in multiple iterations. Each iteration based on one or more of the sorting patterns, analysis and segment content. For example, decision point 220-1 has two possible decisions, decision 230-1 and 230-2. Decision 230-1 leads to a segment 210-2 that has a violent context, while decision 230-2 leads to a segment 210-3 that has a nonviolent context. An advertiser can develop two advertisements for a single product or service to be presented at the same decision point 220-1. In this example, the context of the advertisement for ad location 240-1 can be influenced by the violent nature (content), sorting pattern, and analysis of the following segment. While the context of the advertisement for ad location 240-2 can be influenced by the nonviolent nature (content), sorting pattern, and analysis of the following segment. Advertisement development can be shaped, altered and prejudiced to achieve maximum attention or appeal to the individual and be presented to the individual at the appropriate time.

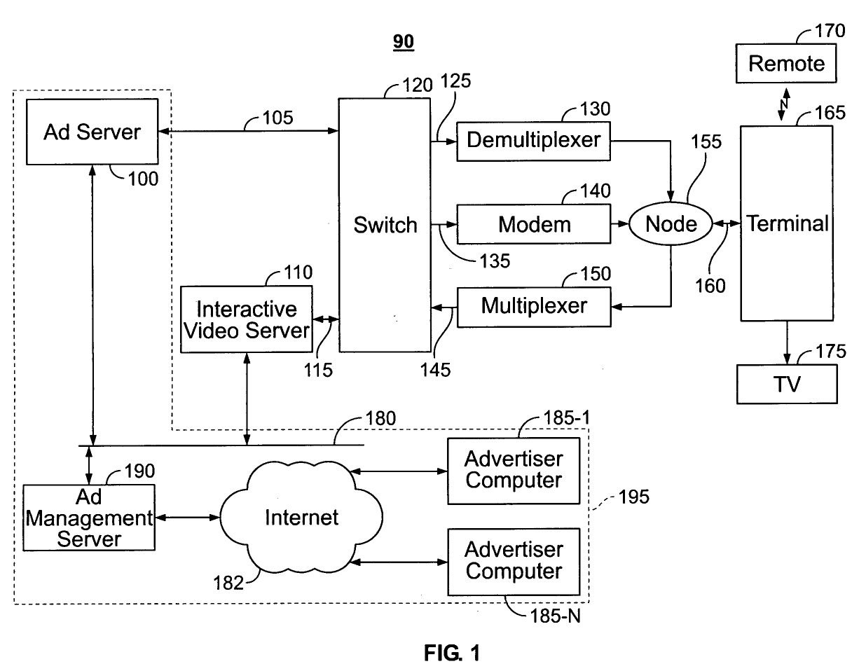

FIG. 1 illustrates an interactive advertisement system 195 in connection with a hybrid fiber coax (HFC) cable CATV system 90. Interactive advertisement system 195 embodies the principles of the invention for providing advertisements to terminals in connection with interactive programs (i.e., interactive narratives, such as videos and animation). As shown in FIG. 1, interactive advertisement system 195 includes ad server 100, ad management server 190, and advertiser computers 185-1 through 185-N, where N is a predetermine number.

As mentioned above, FIG. 2 is a conceptual diagram of the relationship between Program 1 200, program segments 210-1 through 210-7, decision points 220-1 through 220-3, decisions 230-1 through 230-6, advertisement locations 240-1 through 240-6, and type-advertisement locations 250-1 through 250-4.

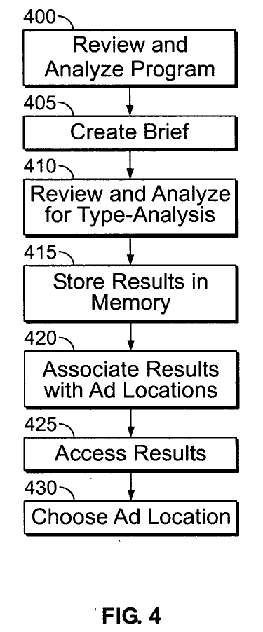

As shown in FIG. 4 blocks 400 and 405, in order to obtain information about Program 1 200 for use by advertisers, an individual (“program reviewer”) reviews Program 1 200 and drafts briefs for each advertisement location 240-1 through 240-6. As mentioned above, the briefs can include analysis about the mind-set or emotional state of individuals who decide to view program segments 210-1 through 210-7 and/or select decisions 230-1 through 230-6. The reviewer can be, for example, an expert or a group of experts skilled in psychology, sociology, Neuro-Linguistic Programming (NLP), VALS (Values and Lifestyles), PRIZM analysis, behavior mapping, ethnography, psychographics, observational research, media planning, account planning, strategic planning, and ad creation. A brief can be based on information related to program segments 210-1 through 210-7 that immediately proceed or follow its corresponding advertisement location 240-1 through 240-6. For example, a brief can be drafted for advertisement location 240-2, based on information related to its following segment 210-3 or based on information related to its proceeding segment 210-1. In any case, as mentioned above, the briefs include information about the viewer's mind-set or emotional state, content, context, characters, etc of Program 1 200 grouped by segments 210-1 through 210-7, decisions points 220-1 through 220-3, and decisions 230-1 through 230-6, and their relationship to one another. Thus, advertisers can create advertisements specifically for advertisement locations 240-1 through 240-6 based on information from their corresponding briefs.

For example, decisions 230-1 and 230-3 can reflect characters or lifestyle choices which are considered “high-risk, adventurous and leader.” Decisions 320-2 and 230-5 can reflect characters or lifestyle choices which are considered “moderate risk or managerial.” Other combinations of decisions can reflect characters or lifestyle choices which are considered “risk-averse or administrative.” Individuals who choose decisions 230-1 and 230-3, for example, receive advertisements associated with advertisement location 240-1 and 240-3. These advertisements can be from different sponsors, but would contain language and imagery that reflect the associated briefs and analysis, in this example, psychographics of a “high risk, adventurous leader.

At block 410, the program reviewer reviews Program 1 200 for type-analysis. An example of type-analysis is generally accepted methodologies such as Myers Briggs Type Indicator®, DiSC®, Neuro-Linguistic Programming sorting patterns or any other predetermined psychographic preferences or affinities, or any other sociological, psychological and personality typing or aggregating techniques.

The program reviewer reviews and analyzes various combinations of decisions 230-1 through 230-6 to determine what “type” of individual ends up selecting and ultimately viewing segments 210-4 through 210-7. For example, one combination of decisions comprise decision 230-2 and decision 230-5. Associated with decisions 230-2 and 230-5 are segments 210-1, 210-3, and 210-6 and type-advertisement location 250-3. In this example, the program reviewer views, studies and analyzes these three segments then categorizes them as a particular “type” for type-advertisement location 250-3, based on the various principles mentioned above. Thus, advertisers with access to this information can create advertisements for type-advertisement locations 250-1 through 250-4 that target a corresponding “type” of individual.

Once the briefs and the type-analysis are completed for Program 1 200, they are stored in ad management server 190, block 415. Ad management server 190 can comprise a group of servers having processing devices and software dedicated to the various processes. More specifically, guided by graphical tools, various dialog boxes, command buttons, and a graphical user interface (GUI), the briefs and type-analysis are entered and stored in a database in ad management server 190. At block 420, each brief and each type-analysis are associated with their corresponding advertisement location 240-1 through 240-6 and type-advertisement location 250-1 through 250-4. The briefs and type-analysis are also associated with their corresponding program, in this example, Program 1.

Alternatively, advertisers can review Program 1 (i.e., various segments, and decision points) and create their own briefs and type-analysis. Furthermore, interactive narratives can be specifically developed to maximize the relationship between the interactive narratives and advertisements. For example, advertisers and interactive narrative producers can jointly create the interactive narratives. These interactive narratives can have segment content, decision points, decisions and related advertisements that are specifically created to maximize individuals' attention.

Referring back to the example, at block 425 using web browsers, advertiser computers 185-1 through 185-N access, via Internet 182, the briefs and type-analysis for Program 1 200 stored in ad management server 190. Dialog boxes, command buttons, and a graphical user interface (GUI) are used to access and present the brief(s) and type-analysis of Program 1 200 for review. At block 430, based on the review, the advertiser chooses one or more advertisement locations 240-1 through 240-6 and type-advertisement locations 250-1 through 250-4. For example, via the dialog boxes, command buttons, and GUI, the advertisement location(s) are chosen and provided by advertiser computer 185-1 to ad management server 190, via Internet 182.

Advertisements can be developed based on the information in the briefs and type-analysis for the chosen ad locations. The advertisements are specifically developed to match the criteria set out in the selected brief(s) and are developed to match the criteria of the selected specific “types,” resulting in advertisements contextually consistent with their locations within the interactive Program 1 (e.g. interactive narrative). Further, an advertiser can develop multiple advertisement alternatives, based on the briefs and analysis.

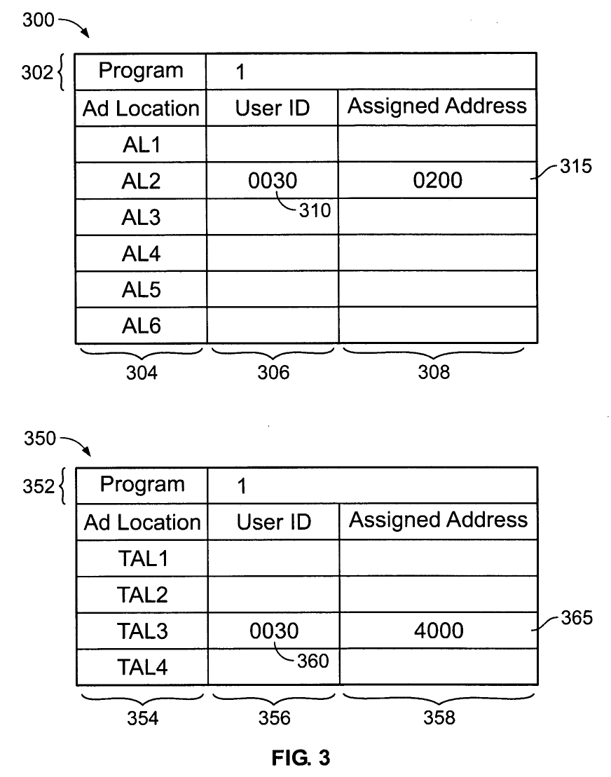

The dialog boxes, command buttons, and GUI provide an interface to tables stored in a database in ad management server 190. To manage the dynamic assignment of advertisement locations to advertisers and their corresponding advertisement(s), an ad location table and a type-ad location table are used. FIG. 3 illustrates an exemplary ad location table (denoted 300) and an exemplary type-ad location table (denoted 350) for Program “1,”, indicated by the entries in rows 302 and 351. These tables are used to manage ad locations, advertiser user ids, and advertisement addresses, which can be combined into one table. Each ad location has an associated advertiser user id, and advertisement address, discussed below. Tables 300 and 350 coincide with decision tree diagram 275, illustrated in FIG. 2.

Referring to table 300, column 304 enumerates each advertisement location for Program 1, denoted as AL1 through AL6, which coincide with ad locations 240-1 through 240-6, shown in FIG. 2. User Id column 306 includes entries identifying user identifications (User Ids) which are associated with various advertisers. Each advertiser is pre-assigned an identifier for identification. Once a user id is entered in User Id column 306, the corresponding ad location in Ad location column 304 is reserved for the advertiser associated with the user id. Thus, ad management server 190 has knowledge of which advertiser is going to advertise at the various ad locations. For example, ad management server 190 receives an entry from advertiser computer 185-1 for advertisement location 240-2 (AL2). Also received by ad management server 190 is a user id value for advertiser computer 185-1, which was set as 0030. User Id value 0030 is entered in User Id column 306 in the field corresponding to ad location AL2. Thus, ad location (AL2) is reserved for the advertiser associated with advertiser computer 185-1.

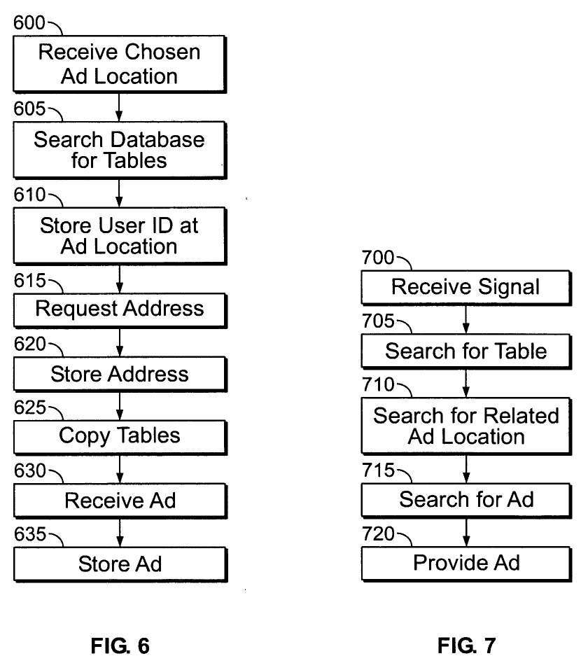

Referring to FIG. 6 block 600, when ad management server 190 receives a chosen ad location(s) from advertiser computer 185-1, routines instruct ad management server 190 to populate table 300 and/or table 350. Continuing with the above example, ad management server 190 receives choices for advertisement location 240-2 and type-advertisement location 250-3 for Program 1 from advertiser computer 185-1. Advertiser computer 185-1 has associated with it, a unique user identification, User Id 0030. At block 605, routines instruct ad management server 190 to search its databases for tables related to Program “1”. In this example, tables 300 and 350 are identified because rows 302 and 352 each have an entry “1,” which denotes Program 1. At block 610, routines then instruct ad management server 190 to store in field 310, User Id 0030. Field 310 is selected based on the chosen advertisement location, which in this example, is advertisement location 240-2. Advertisement location 240-2 corresponds to AL2 in Ad Location column 304.

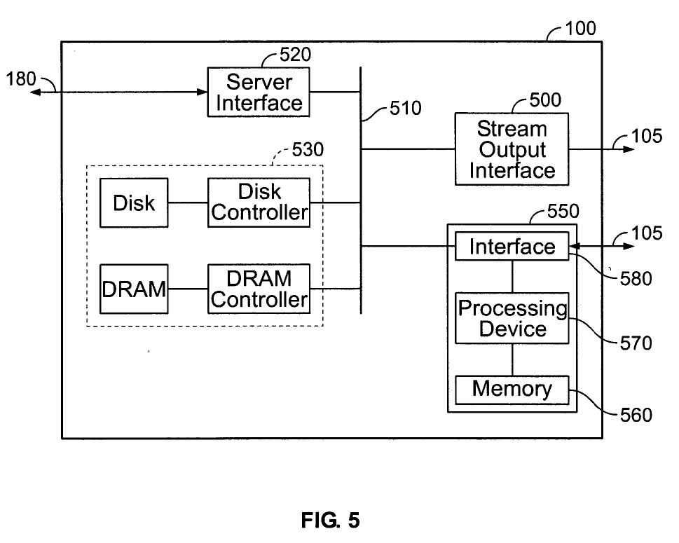

Also associated with the entries in Ad Location column 304 and User Id column 306 are the entries in Address column 308. Address column 308 stores address entries representative of locations of advertisements stored in memory system 530, shown in FIG. 5. Memory system 530 includes DRAM, DRAM controllers, disks and disk controllers. At block 615, routines instruct ad management server 190 to request an address associated with available memory in memory system 530 from ad server 100. Ad server 100 can comprise a group of servers having processing devices and software dedicated to the various processes or could be combined with ad management server 190 into a single system. The address represents memory space available in memory system 530 for storing an advertisement. Routines in memory 560 instruct processing device 580 to reserve an address and memory, and provide the address to ad management server 190, via server interface 520 and network bus 180. At block 620, routines instruct ad management server 190 to populate field 315 with the address (e.g. 0200) in Address column 308.

Table 350 is populated in a similar manner to table 300. Like table 300, table 350 has a row 352 for entries denoting the particular program that table 350 represents. In this example, the program is Program “1” denoted by the entry “1” in row 352. The entries in the fields of User Id column 356 and Address column 358 are associated with the entries in the fields of Ad Location column 358. One difference between table 300 and table 350 is the entries in Ad Location column 354 enumerate a different type of advertisement location, i.e., type-advertisements 250-1 through 250-4. Column 354 identifies the various ad locations for Program 1, which are denoted TAL1-TAL4 and coincide with ad locations 250-1 through 250-4, shown in FIG. 2.

In this example, ad management server 190 receives an entry from advertiser computer 185-1 for type-advertisement location 250-3 (TAL3). The User Id value for advertiser computer 185-1 is set as 0030 in User Id column 306 at field 360 and an Address 4000 is set in field 365, by ad management server 190. Thus, ad location (TAL3) is reserved for the advertiser associated with advertiser computer 185-1. As mentioned above, routines in memory 560 instruct processing device 580 to reserve an address (e.g. 4000) and memory, and provide the address to ad management server 190, via server interface 520 and network bus 180.

At block 625, copies of tables 300 and 350 are provided to ad server 100 and stored in a database in memory 560 of controller 550 for use in connection with hybrid fiber coax (HFC) cable CATV system 90. When an entry is stored in tables 300 or 350, routines instruct ad management server 190 to provide updated information for the tables stored in ad server 100, via network bus 180.

When an advertisement is developed, using the dialog boxes, command buttons, and GUI advertiser computer 185-1 provides the advertisement in a well known compressed form to ad management server 190, via Internet 182, at block 630. Alternatively, the advertisement can be provided and downloaded to ad management server 190, for example, via DVD. Associated with the advertisement is data related to User Id, Program Number and Ad Location. In this example, the data is 0030, 1 and AL2. At block 635, routines instruct ad management server 190 to store the advertisement and data in memory. The routines further instruct ad management server 190 to provide the advertisement and data to advertisement server 102 via network bus 180. Referring to FIG. 5, controller 550 includes processing device 570 which is connected to memory 560 and interface 580. Processing device 570 locates the copy of table 300 stored in memory 560 for Program 1 and retrieves the address associated with the data, e.g., 0030, 1 and AL2. In this example, field 365 has the address entry 4000. In accordance with routines stored in memory 560, processing device 570 stores the advertisement at address location 4000 in memory system 530.

As shown in FIG. 1, the general architecture of the hybrid fiber coax (HFC) cable CATV system 90 includes interactive video server 110, switch 120, demultiplexer 130, forward control channel 125, modem 140, multiplexer 150, node 155, terminal 165, remote 170, and television set 175.

When a subscriber at terminal 165 selects an interactive program (e.g. interactive narrative) to view, the subscriber enters the appropriate code in remote 170 and remote 170 provides the code to terminal 165. In this example the Program Number is “1.” Terminal 165 is pre-assigned with an identifier for identifying the terminal and in this example the value of the Identifier is set to 0169. Terminal 165 can be, for example, a set-top box, game device, computer or processing device. Terminal 165 converts the code to a radio frequency return signal and provides the signal, including the program number and terminal identifier, to node 155. Although a single terminal is illustrated in FIG. 1, it should be noted that multiple terminals for multiple subscribers can be implemented in the system.

Multiplexer 150 combines the return signal with return signals from other subscribers onto a single stream of return channels 145 and provides the return signal to switch 120. Multiplexer 150 can be for example an asynchronous transfer mode (ATM) multiplexer and switch 120 can be for example, an ATM switch. Switch 120 integrates multiple incoming data, voice, and video lines into a single connection that are provided to interactive video server 110 via high-speed channel 115. Interactive video server 110 stores compressed digital videos on disks.

Interactive video server 110 assembles and provides the selected interactive program stream (e.g. including digital interactive narrative) and the terminal identifier 0169 of the subscriber, to switch 120. Switch 120 provides the interactive program stream to modem 140 via high-speed communications link 135, where modem 140 encodes the program stream for use in high-speed transmission to node 155. Modem 140 can be for example, quadrature amplitude modulation (QAM) modem.

At node 155, the program stream is converted from an optical signal to a radio frequency signal where it is provided to and decoded by terminal 165, which has the corresponding identifier 0169. The selected program stream is then derived and provide for viewing via television 175 for the subscriber.

When the program stream reaches a decision point (e.g., 220-1 through 220-3) in Program 1, the subscriber is presented with a question. Referring to FIG. 2, the first question (decision point 220-1) has two choices, either decision 230-1 or decision 230-2. In this example, the subscriber selects decision 230-2 by entering the appropriate Value (e.g., 2) via remote 170. Terminal 165 receives the Value 2 and converts the Value 2, Program Number 1 and Terminal Identifier 0169 to a radio frequency return signal and provides the return signal to node 155. Conversely, if the subscriber selects decision 230-1, terminal 165 provides the Value “1” to node 155. Multiplexer 150 combines the return signal with return signals from other subscribers onto a single stream of return channels 145 and provides the return signal to switch 120.

The return signal is directed to interactive video server 110, where Program 1 is paused while ad server 100 provides the appropriate advertisement. A copy of the return signal is directed to high-speed channel 105 and ad server 100, which stores compressed advertisements on disks. Referring to FIG. 7 block 700, interface 580 receives the return signal and routines stored in memory 560 instruct processing device 570 to read the Program Number, Value, and Terminal Identifier from the return signal. In this instance, the Program Number is 1, the Value is 2 (choice 2, i.e., 230-2) and the Terminal Identifier is 0169. At block 705, routines instruct processing device 570 to search memory 560 for tables related to “Program 1”. As mentioned above, copies of tables 300 and 350 are stored in a database within memory 560.

When processing device 570 locates table 300, at block 710, routines instruct it to search table 300 for Ad Location 304 and an entry related to value 2 (choice 2, decision 230-2). In this example, Value 2 is associated with entry AL2, which according to table 300, corresponds to User Id 0030 (field 310) and Address 0200 (field 315). At block 715, routines instruct processing device 570 to retrieve the advertisement at Address 0200 and to assemble the Terminal Identifier 0169 with the advertisement data stream. The data stream is provided to stream output interface 500 and high-speed channel 105. At block 720, the advertisement data stream is provided to switch 120 and modem 140, via digital channel 135. At node 155 the advertisement data stream transfers from an optical-fiber line to coaxial cable for transmission to terminal 165. Terminal 165, which has identifier 0169, receives the advertisement data stream and decompresses and displays it via television 175. The subscriber receives an advertisement associated with Program 1, Ad location AL2 (ad location 240-2) and Advertiser 0030. As disclosed above, the content of the advertisement is associated with content and/or analysis of the segments, decisions, decision points and any combination thereof, of the interactive program. In this example, the advertisement is associated with information related to interactive Program 1, ad location AL2. At the completion of the advertisement, interactive video server 110 provides the appropriate segment within Program 1 to terminal 165.

The foregoing merely illustrates the principles of the invention. It will thus be appreciated that those skilled in the art will be able to devise numerous other arrangements which embody the principles of the invention and are thus within its sprit and scope.

For example, based on the above disclosure, it is apparent that the Internet and wireless broadband can readily accommodate the principles of the invention.

In addition, based on the disclosure, it is apparent that the principles of the invention can readily accommodate interactive television programs that allow individuals to make choices for various events, such as horse racing or dating services. With these types of interactive television programs, individuals can place bets or make choices based on, for example, long odds/short odds or

We claim:

1. A method for providing advertisements over a communications network, the communications network delivering at least an interactive program stream containing interactive program content, the method comprising:
receiving at least an indicator indicative of an action related to the interactive program content;
locating an advertisement within a group of advertisements, the advertisement being associated with the action and including content based on information related to the interactive program content; and
providing at least an advertisement data stream which contains the advertisement.

2. The method of claim 1 wherein the information is content about one or more segments proceeding and/or following the action.

3. The method of claim 1 wherein the information is content about one or more decisions points.

4. The method of claim 1 wherein the information is an analysis of one or more segments.

5. The method of claim 4 wherein the analysis provides a context of the one or more segments.

6. The method of claim 4 wherein the analysis provides a mind-set and/or an emotional state of an individual viewing the one or more segments.

7. The method of claim 1 wherein the information is one or more answers presented.

8. The method of claim 1 wherein the information is behavior patterns revealed by choosing one or more segments.

9. The method of claim 1 wherein the information is a culmination of actions.

10. The method of claim 1 wherein the information is one or more actions.

11. The method of claim 1 wherein the information is related to personality types determined by review and/or analysis of one or more segments.

12. The information of claim 1 wherein the information is determined by an advertiser.

13. The method of 1 wherein the information is type-analysis.

14. The method of claim 13 wherein the type-analysis includes psychographic preferences or affinities, sociological, psychological and personality typing or aggregating techniques.

15. The method of claim 13 wherein the type-analysis includes Myers Briggs Type Indicator®, DiSC®, and/or Neuro-Linguistic Programming sorting patterns.

16. The method of claim 1 wherein the advertisement data stream is provided in response to the action.

17. The method of claim 1 further comprising providing one or more segments within the interactive program content in response to the action before providing at least an advertisement data stream which contains the advertisement.

18. The method of claim 1 wherein the interactive program content is developed to maximize relationships between the interactive program content and advertisements.

19. A system for providing for providing advertisements over a communications network, the communications network delivering at least an interactive program stream containing interactive program content, the system comprising:
an interface for receiving over the communications network at least an indicator indicative of a an action related to the interactive program content;
a memory for storing at least a group of advertisements; and
a processing device responsive to receipt of the indicator, for locating an advertisement within the group of advertisements stored in the memory, the advertisement being associated with the action and including content based on information related to the interactive program content, and for providing over the communications network at least an advertisement data stream which contains the advertisement.

20. The system of claim 19 wherein the information is content about one or more segments proceeding and/or following the action.

21. The system of claim 19 wherein the information is content about one or more decisions points.

22. The system of claim 19 wherein the information is an analysis of one or more segments.

23. The method of claim 19 wherein the information is determined by an advertiser.

24. The system of claim 22 wherein the analysis provides a context of the one or more segments.

25. The system of claim 22 wherein the analysis provides a mind-set and/or an emotional state of an individual viewing the one or more segments.

26. The system of claim 19 wherein the information is one or more answers presented.

27. The system of claim 19 wherein the information is behavior patterns revealed by choosing one or more segments.

28. The system of claim 19 wherein the information is a culmination of actions.

29. The system of claim 19 wherein the information is one or more actions.

30. The system of claim 19 wherein the interactive program content is developed to maximize relationships between the interactive program content and advertisements.

31. The system of claim 19 wherein the information is related to personality types determined by review and/or analysis of one or more segments.

32. The system of 19 wherein the information is type-analysis.

33. The system of claim 32 wherein the type-analysis includes psychographic preferences or affinities, sociological, psychological and personality typing or aggregating techniques.

34. The system of claim 32 wherein the type-analysis includes Myers Briggs Type Indicator, DiSC®, and/or Neuro-Linguistic Programming sorting patterns.

35. The system of claim 19 wherein the advertisement data stream is provided in response to the action.

36. The system of claim 19 further comprising providing one or more segments within the interactive program content in response to the action before providing at least an advertisement data stream which contains the advertisement.

37. The system of claim 19 wherein the network comprises an interactive cable television network.

38. The system of claim 19 wherein the network comprises Internet.

39. The method of claim 19 wherein the network comprises a wireless component.

40. A method for maintaining records in a database comprising:
receiving at least a collection of first data items, at least one of the first data items related to a request for an advertisement location from a collection of advertisement locations associated with various decision points within an interactive program;
disposing the first data items in a plurality of fields arranged to reserve the advertisement location;
receiving at least a collection of second data items, at least one of the second data items being an advertisement related to the request; and
maintaining a record of the relationship among the first data items and the second data items in the database having a plurality of fields.

41. The method of claim 40 wherein the advertisement location is further associated with third data items including content and/or analysis of the interactive program.

42. The method of 41 wherein the third data items include information related to segment content of the interactive program.

43. The method of claim 41 wherein the third data items include information related to segment patterns in the interactive program.

44. The method of claim 41 wherein the third data items include information related to one or more decision points.

45. The method of claim 41 wherein the third data items include information related to type-analysis.

46. The method of claim 45 wherein the type-analysis includes Myers Briggs Type Indicator®, DiSC®, and/or Neuro-Linguistic Programming.

47. The method of claim 40 wherein the collection of advertisement locations are associated with locations prior to and/or after decisions points, and/or prior to and/or after decisions in the interactive program.

48. The method of claim 40 wherein the collection of advertisement locations are associated with locations prior to and/or after segments in the interactive program.

49. The method of claim 40 wherein the second data items is received via a DVD.

50. The method of claim 40 further comprising receiving a collection of fourth data items, at least one of the fourth data items being a request for an advertisement.

51. The method of claim 50 further comprising providing an address for locating the advertisement.
